(19) United States
(12) Patent Application Publication
(10) Pub. No.: US 2013/0086239 A1
(43) Pub. Date: Apr. 4, 2013

(54) Network application based intranet

(71) Applicant: Dantech Systems, LLC, Stony Brook, NY (US)

(72) Inventors: Daniel Siegel, St. James, NY (US); Daniel Fourman, Stony Brool, NY (US)

(73) Assignee: Dantech Systems, LLC, Stony Brook, NY (US)

(21) Appl. No.: 13/573,665

(22) Filed: Oct. 3, 2012

Related U.S. Application Data
(60) Provisional application No. 61/542,524, filed on Oct. 3, 2011.
(60) Provisional application No. 61/663,920, filed on Jun. 25, 2012.

(51) Int. Cl. G06F 15/173

(52) U.S. Cl. 709/223

(57) ABSTRACT

A network application based intranet with enhanced network response and reduced hardware is disclosed. By incorporating traditional network address assignment, domain name resolution, web server and routing jobs into a single host computing device such as a laptop or a backend server device, network response can be improved while also reducing the number of network devices needed and their corresponding cost. The traditional routing functionality of the router device can be eliminated, with the router device now functioning as a wireless communication point whereby devices are connected to it, but data sent to it is immediately forwarded to the host computing device via a dedicated port on the host computing device.

### CROSS REFERENCE TO RELATED APPLICATIONS

This application claims the benefit of U.S. Provisional Patent Application No. 61/542,524, filed Oct. 3, 2011, and U.S. Provisional Patent Application No. 61/663,920, filed Jun. 25, 2012, the entireties of which are incorporated herein by reference.

### FIELD OF THE DISCLOSURE

This relates to local networks, including implementing an intranet to provide a network application with enhanced network response and reduced hardware.

### BACKGROUND

Several challenges exist in providing a network application to a large group of users at a particular location.

For example, providing access to a web site over the Internet in a venue such as a conference hall or sports stadium can be costly due to hourly or daily fees charged by the venue for Internet access, yet result in poor network response due to intentional throttling of the Internet connection because of the large number of client devices clogging up a single gateway to the Internet at the same time. Applications provided over the Internet are also vulnerable to cyber attacks, which can bring down a web site in its entirety.

Attempting to bypass the Internet by hosting a network application via an ad-hoc network comes with its own challenges. An ad-hoc network is typically a network created by one device and co-supported by any device that joins. In ad-hoc network, each device that joins assigns itself an IP address and data sent by one device is sent to all devices currently within the network, whether that device has requested the information or not. Thus, due to this large amount of unnecessary network traffic there is a severe limitation of devices that can join the network and performance degrades as more devices join. Further, because ad-hoc networks do not have the capability of resolving domain names into their corresponding network addresses, to access a web site hosted on one of the network devices one must type that device's IP address into the browser, which is not user friendly.

### SUMMARY

A network application based intranet with enhanced network response and reduced hardware is disclosed.

By incorporating traditional network address assignment, domain name resolution, web server and routing jobs into a single host computing device such as a laptop or a backend server device, network response can be improved while also reducing the number of network devices needed, thereby reducing cost. The traditional routing functionality of the router device can be eliminated, with the router device now functioning as a wireless (e.g., WiFi) communication point whereby devices are connected to it, but data sent to it is immediately forwarded to the host computing device via a dedicated port on the host computing device.

In contrast to an ad-hoc network, a network according to the present disclosure can rely on a host computing device that only delivers the appropriate data to the specific network device that has requested it. Any client devices that join the network can be assigned an IP address by the host computing device from a pre-specified pool of IP addresses, and the limitation of devices is determined by the maximum possible number of IP addresses that can exist in an particular Internet Protocol configuration (e.g., approximately 5 billion possible addresses (2̂32) in the IPv4 configuration). It is noted, however, that the actual physical capacity can be dependent upon the devices connected, the hardware power of the host computing device, and the hardware power of the wireless communication point for example. To access a webpage being hosted on the host computing device, one can simply type in one of several pre-configured URLs into the client browser once joined to the network.

A network application based intranet according to the present disclosure can be directed to a group feedback system that utilizes an intranet over WiFi to facilitate the audience response needs of various group settings. In addition to the advantages described above, the use of WiFi also eliminates the need to rely on a cellular data network, along with associated cellphone data carrier restrictions as well as cell phone signal reception issues, for providing the network application. WiFi also does not require a direct line of sight for communication to occur over the network, as is the case with infrared based communication technologies.

Thus, the system of the present disclosure can allow for the creation of a secure environment in which to conduct audience response polls, tests, or other interactive events. This system negates the need for customers to purchase specialized audience response systems and can replace them with the WiFi equipped devices the customers already own.

### BRIEF DESCRIPTION OF THE DRAWINGS

FIG. 1 illustrates an example of a network application based intranet architecture.

FIG. 2 illustrates an example of a network application based intranet process.

FIG. 3 illustrates an example of an audience response system.

FIGS. 4 and 5 illustrate examples of a network adaptor configuration for a host computing device.

FIGS. 6 and 7 illustrate examples of a configuration for a wireless communication point.

FIG. 8 illustrates an example of a setup user interface for an audience response system.

FIG. 9 illustrates an example of a client device user interface for an audience response system.

FIG. 10 illustrates an example of an administrator console user interface for an audience response system.

FIG. 11 is a block diagram of an example of a computing device.

### DETAILED DESCRIPTION

The present disclosure is directed to a network application based intranet with enhanced network response and reduced hardware. Although the embodiments disclosed herein describe a network in the context of an intranet, the system is not so limited and can be used to provide a network of any suitable scale and connection to other networks, such as the Internet, in accordance with the teachings of the present disclosure.

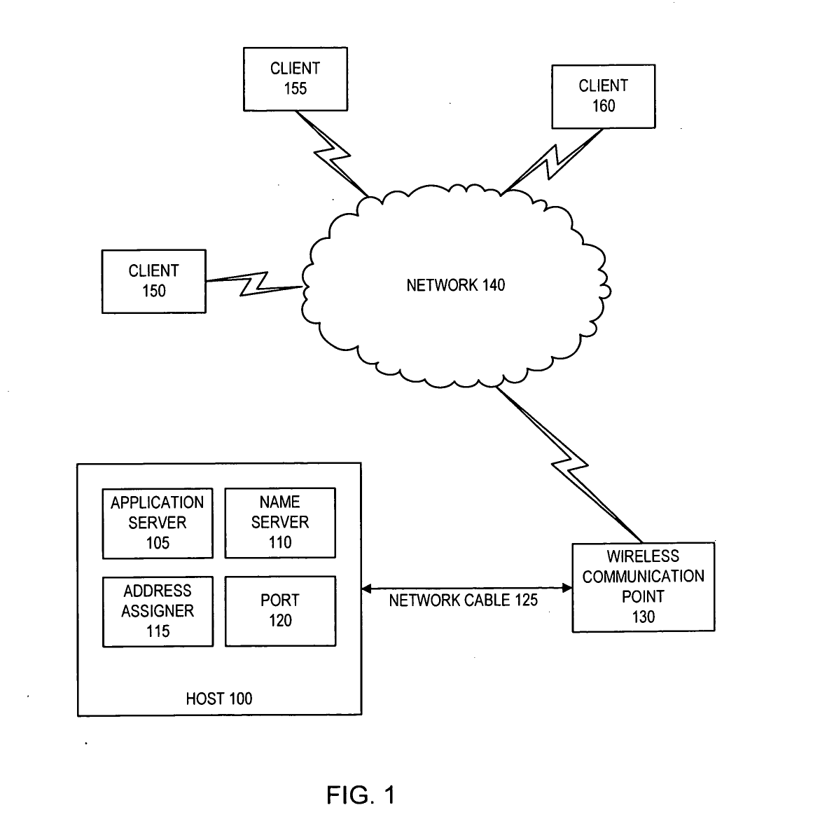

FIG. 1 illustrates an example of a network application based intranet architecture. In the illustrated embodiment, network 140 can comprise an intranet created by connected local devices over a wireless (e.g., WiFi) signal. WiFi refers to the wireless networking capability that allows computing devices to communicate with one another using the Transmission Control Protocol/Internet Protocol (TCP/IP) protocol suite. The TCP/IP protocol suite refers to a set of rules governing the transport of data across a network.

The local devices can comprise host 100, which can comprise a host computing device associated with network 140, and client 150, client 155 and client 160, which can represent any wireless capable computing device within range of wireless communication point 130.

Examples of wireless capable computing devices include portable or stationary computing devices that can connect to a private wireless network and have a web browser. Examples of suitable portable computing devices include Apple iPad® or iPhone®, an Android based tablet or smart phone, a tablet or smart phone running the Blackberry, WebOS or Windows mobile platform, or a laptop running a supported operating system such as Windows, OSX, or Debian. Examples of suitable stationary computing devices include a desktop PC running a supported operating system such as Windows, OSX, or Debian, connecting wirelessly to network 140 via a wireless networking card.

Wireless communication point 130 can comprise a transceiver configured to transmit wireless signals to client 150, client 155 and client 160 connected to network 140 and to receive wireless signals from client 150, client 155 and client 160. Wireless communication point 130 can comprise a device connectable to host 100 via network cable 125, which can comprise any suitable wired network line such as a category 5e or category 6 Ethernet straight-through patch cable that can connect to a free RJ45 jack of host 100. In other embodiments, wireless communication point 130 can be installed on host 100.

Host 100 can implement one or more installed network components such as application server 105, name server 110, address assigner 115 and port 120.

Application server 105 can comprise a server, such as a web server, configured to provide an application on network 140. The application can comprises any suitable network application, such as a group response application configured to conduct an interactive event with a group of people carrying wireless capable client computing devices within a range of wireless communication point 130.

Name server 110 can comprise a server, such as a Domain Name System (DNS) server, configured to resolve a network name into a network address associated with network 140. Because the system comprises its own name server, the system can also redirect any web address, even one with a suffix (.com, .org, etc.) not recognized by the World Wide Web Consortium (W3C), if that web address is specified in name server 110. For example, a web address such as new.york would be possible, whereas york is not a recognized standard internet suffix.

Address assigner 115 can comprise a server, such as a Dynamic Host Configuration Protocol (DHCP) server, configured to assign a network address to a client computing device connecting to network 140. Address assigner 115 can assign any suitable network address, such as IPv4 addresses and IPv6 addresses.

Application server 105, name server 110 and address assigner 115 can communicate with each other without using local network interface hardware of host 100 (e.g., by using a loopback interface), thereby reducing the load on network resources.

Port 120 can comprise a non-physical location within host 100 to which the data received by wireless communication point 130 is addressed. Wireless communication point 130 can be configured without any routing functionality, such that it merely forwards to host 100 all data received from any client computing device connected to network 140.

In one embodiment host 100 can comprise a portable computing device such as a laptop. In another embodiment, host 100 can comprise a backend server computing device, such as a server computing device (e.g., a blade server) mounted in a non-portable enclosure (e.g., a rack).

In this other embodiment in which all of the functions previously designated for the portable computing device are now placed on a server system, the wireless communication point can comprise the existing access point network within the organization or complex. A client can connect on to a specific wireless network broadcasted by the AP's around the organization/complex, then that communication can be directly transmitted to the backend server. After that point the backend server functions the same way the portable computing device functions in the illustrated embodiment, just on a faster and broader scale.

Network 140 can be isolated from (i.e., not connected to) other networks, such as the Internet, or can connect to other networks. To provide access to an external network for client computing devices connected to network 140, host 140 can share a connection to the external network and forward, via a DNS forwarder for example, external network requests (e.g., uniform resource locator (URL) requests to an Internet site) to a DNS server associated with the external network.

By incorporating traditional network address assignment, domain name resolution, web server and routing jobs into a single host computing device such as a laptop or a backend server device, network response can be improved while also reducing the number of network devices needed, thereby reducing cost. The traditional routing functionality of the router device can be eliminated, with the router device now functioning as a wireless communication point whereby devices are connected to it, but data sent to it is immediately forwarded to the host computing device via a dedicated port on the host computing device.

In contrast to an ad-hoc network, a network according to the present disclosure can rely on a host computing device that only delivers the appropriate data to the specific network device that has requested it. Any client devices that join the network can be assigned an IP address by the host computing device from a pre-specified pool of IP addresses, and the limitation of devices is determined by the maximum possible number of IP addresses that can exist in an particular Internet Protocol configuration (e.g., approximately 5 billion possible addresses (2̂32) in the IPv4 configuration). It is noted, however, that the actual physical capacity can be dependent upon the devices connected, the hardware power of the host computing device, and the hardware power of the wireless communication point for example. To access a webpage being hosted on the host computing device, one can simply type in one of several pre-configured URLs into the client browser once joined to the network.

A network application based intranet according to the present disclosure can be directed to a group feedback system that utilizes an intranet over WiFi to facilitate the audience response needs of various group settings. In addition to the advantages described above, the use of WiFi also eliminates the need to rely on a cellular data network, along with associated cellphone data carrier restrictions as well as cell phone signal reception issues, for providing the network application. WiFi also does not require a direct line of sight for communication to occur over the network, as is the case with infrared based communication technologies.

Thus, the system of the present disclosure can allow for the creation of a secure environment in which to conduct audience response polls, tests, or other interactive events. This system negates the need for customers to purchase specialized audience response systems and can replace them with the WiFi equipped devices the customers already own.

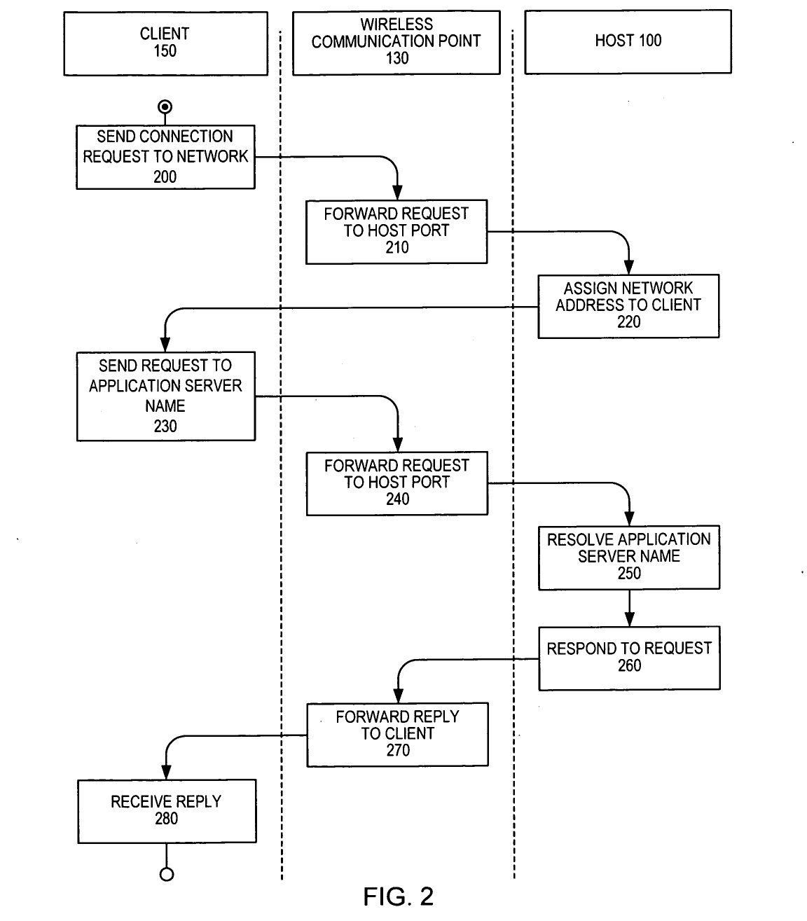

FIG. 2 illustrates an example of a network application based intranet process. In the illustrated embodiment, client 150 can be within range of wireless communication point 130 and discover network 140 from wireless communication point 130 using its standard wireless networking capabilities. Once network 140 is discovered, client 150 can request to connect to network 140 (block 200). Wireless communication point 130 can receive the connection request and forward that request to port 120 of host 100 (block 210). Upon receiving the connection request, address assigner 115 can assign a network address to client 150 (block 220) for use in network 140 to complete the connection.

In one embodiment, the system can be configured as a captive portal upon connection, redirecting users automatically to a specific network application hosted by application server 105. In other embodiments, the user can enter a network name such as a URL to reach an application hosted by application server 105.

Once connected to network 140, client 150 can send a request to application server 105 based on the application server's network name, such as a URL (block 230). Wireless communication point 130 can receive the request and forward it to port 120 of host 100 (block 240). Upon receiving the request, name server 110 can resolve the application server name into a network address associated with network 140 (block 250) and forward the request to application server 105 via port 120. Upon receiving the request, application server 105 can act on and respond to the request (block 260), sending the response to wireless communication point 130 for forwarding (block 270) to client 150 (block 280).

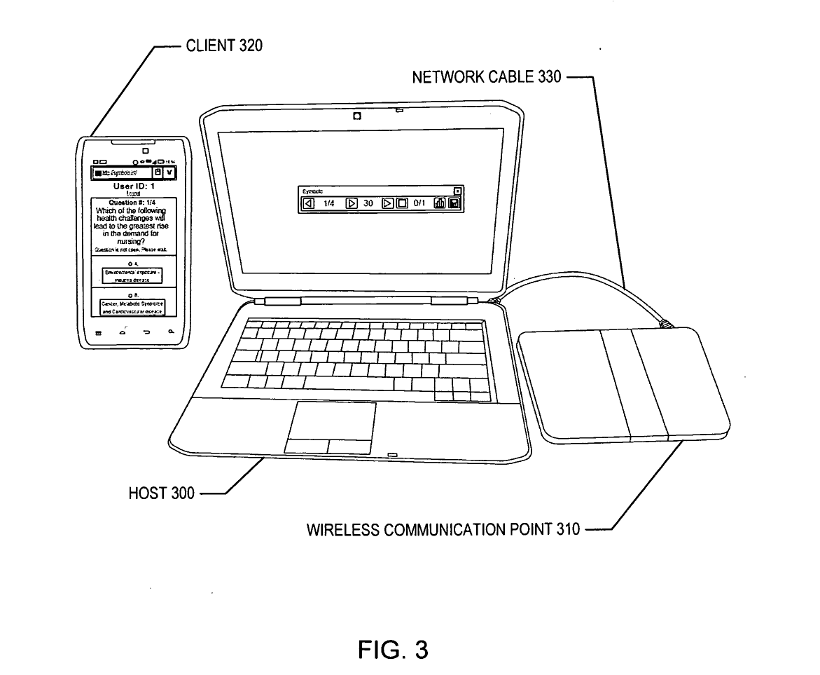

FIG. 3 illustrates an example of an audience response system in which host 300 comprises a laptop connected to wireless communication point 310 via network cable 330, and client 320 comprises a smart phone connectable to the network deployed by host 300 and wireless communication point 310. In this embodiment, host 300 corresponds generally to host 100, wireless communication point 310 corresponds generally to wireless communication point 130, network cable 330 corresponds generally to network cable 125 and client 320 corresponds generally to any of client 150, client 155 and client 160.

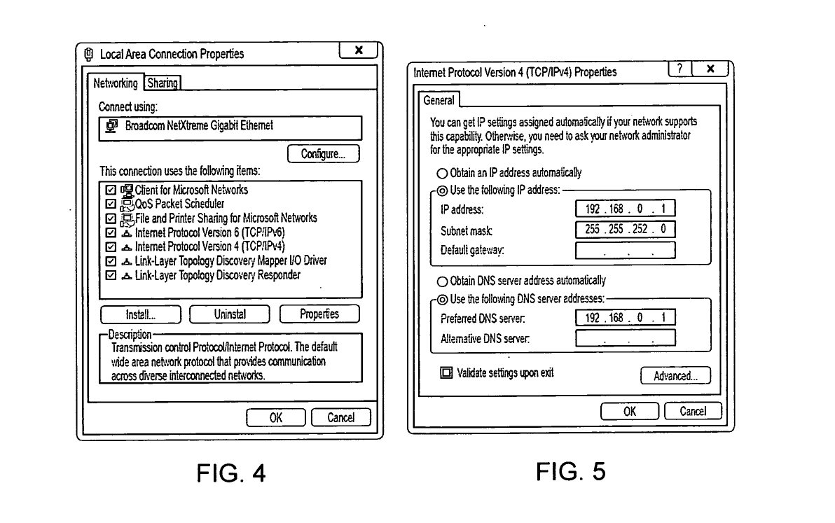

In the embodiment shown in FIG. 3, host 300 can be configured to deploy network 140 by configuring its network adaptor as shown in FIGS. 4 and 5. FIG. 4 shows the local area connection properties associated with host 300, and FIG. 5 shows the IP settings. In particular, the IP settings specify that host 300 is assigned to network (IP) address 192.168.0.1, and that the same network address is to be used for name server 110.

Address assigner 115 and name server 110 can comprise an open source dual DHCP DNS server with the following modifications made to the server configuration file:

[SERVICES]

#Specify the service you want to use

#Default is both services

DNS

DHCP

In the above section of the configuration file, removing the semicolons at the beginning of the “DNS” and “DHCP” lines enable those services.

[LISTEN-ON]

#Specify the Interfaces you would like Server to listen

#if you have more than one NIC card on your server

#always specify which cards will listen DHCP/DNS requests

#Requests from different Interfaces look for matching DHCP ranges.

#Requests from relay agents look for matching range to relay agent IP.

#upto 125 interfaces can be specified.

#Default is all Static interfaces

192.168.0.1

In the above section of the configuration file, the network address “192.168.0.1” of host 300 is specified as the port 120 for listening for DHCP/DNS requests.

[DNS-ALLOWED-HOSTS]

#These are permitted hosts for DNS Query.

#Hosts having IP address within these ip ranges

#only will be responded to DNS requests.

#Hosts “queried for” has nothing to do with these ranges.

#125 ranges can be specified.

#DHCP Client ranges are automatically included

#use second example for allowing all hosts

1.0.0.1-255.255.255.254

In the above section of the configuration file, the “1.0.0.1-255.255.255.254” line specifies that all network addresses are allowed access to host 300.

[DOMAIN-NAME]

#This is local zone/domain for this Server

#Default is workgroup (not authorised) if not specified

#There are two formats for this

#workgroup

#workgroup=10.10.in-addr.arpa

#just workgroup means this is not authorized server

#with default domain name workgroup

#workgroup=10.10.in-addr.arpa means this is authorized server for

#zone workgroup and network 10.10.0.0

#authorized DNS Server will support AXFR and Zone Transfer

#and Zone replication. It will also send

#NS records with DNS queries and NS queries will be responded.

SBS_Clickers

In the above section of the configuration file, any name, such as “SBS_Clickers”, can be added to bring any device connected under a communal network name. Unlike traditional networks, this does not need to reflect an actual domain name on the internet

[DNS-SERVERS]

#If DNS Service is enabled

#These servers are used

#as default Forward DNS Servers

#DNS Server here would be overridden by

#servers specified in [CHILD-ZONES] section.

#However If only DHCP service is used,

#these are passed as local DNS Servers,

#unless overridden by DHCP-OPTIONS or client OPTIONS

#Program auto detects if not specified

192.168.0.1

In the above section of the configuration file, the network address “192.168.0.1” of host 300 is specified as the port 120 to which DNS requests are to be directed.

[HOSTS]

#This is where hosts and their IPs needs to be specified

#DNS will resolve as per entries here, in addition to

#DHCP alotted addresses.

#Bare names automatically assume local domain-name.

#hosts here need not be local

#reverse entry is automatic.

#MX and ALIASs needs to be given in respected sections

#no alias or wild cards in this section

#No limit to no. of entries here !

www.symbolo.int=192.168.0.1

symbolo.int=192.168.0.1

In the above section of the configuration file, any URLs to be directed to application server 105 on host 300 are listed here with an equals to the network address of host 100. In this example if client 320 were to send a URL request to “www.symbolo.int” over network 140, client 320 would be lead to the website hosted by application server 105 on host 300. The URL's listed here can have any suffix as they are all controlled internally by host 300.

[DHCP-RANGE]

#This is first and simple DHCP range section example,

#This example may be good enough for simple/home use.

#If you need range filters, look at example below

DHCP_Range=192.168.0.3-192.168.3.255

#Following are range specific DHCP options.

#You can copy more options names from [DHCP-OPTIONS]

Subnet_Mask=255.255.252.0

Router=192.168.0.2

#Lease Time can be different for this Range

Lease_Time=3600

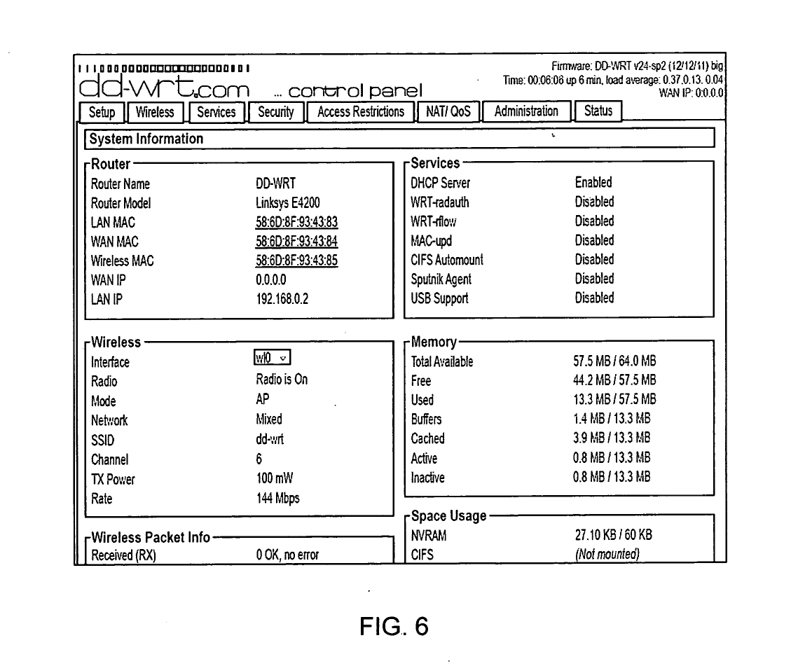

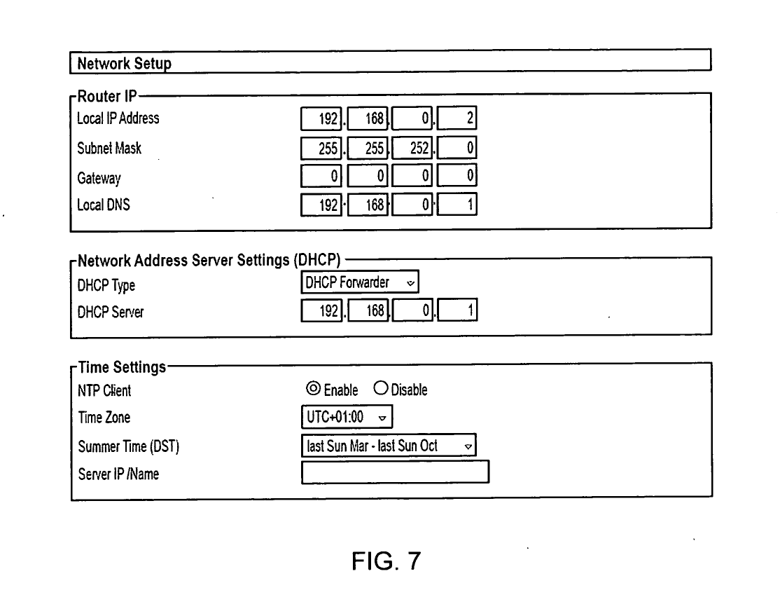

In the above section of the configuration file, the “DHCP_Range” parameter specifies the range of addresses that can be assigned to host 300. Based on the value set for this parameter, the DHCP range can be decreased if fewer devices are to be allowed or increase if more devices are to be allowed. The “Subnet_Mask” parameter is set to equal the subnet mask of host 300 (as shown in FIG. 4) and wireless communication point 310 (as shown in FIG. 7). The “Router” parameter is the network address that is assigned to wireless communication point 310, which in this example is “192.168.0.2” as shown in FIGS. 6 and 7. The “Lease_Time” parameter is the amount of time in seconds that a connecting device can capture and holds its address on network 140.

Application server 105 in this embodiment can comprise an open source Apache HTTP server with the following modifications made to the server configuration file:

#ServerName gives the name and port that the server uses to identify itself.

#This can often be determined automatically, but we recommend you specify

#it explicitly to prevent problems during startup.

#If your host doesn't have a registered DNS name, enter its IP address here.

ServerName localhost:80

In the above section of the configuration file, “localhost” refers to the network address of host 300.

Wireless communication point 310 can comprise a commercial wireless router such as a Cisco Linksys E4200 flashed with custom firmware, such as open source DD-WRT WLAN firmware. Wireless communication point 310 can be configured as shown in FIGS. 6 and 7.

FIG. 6 shows a main screen of wireless communication point 310, which indicates the network address of 192.168.0.2 as specified above. FIG. 7 shows a network setup screen of wireless communication point 310 after editing the stock settings from the flashed firmware. The router thus no longer acts as a traditional router, and more as a wireless gateway between host 300 and any users in connection. The local IP address reflects the unique address 192.168.0.2 assigned to the router statically. The subnet mask reflects that from host 300, and the DNS also points to host 300 (i.e., 192.168.0.1) allowing incoming requests to be answered directly by host 300. The DHCP settings as well point to host 300 (i.e., 192.168.0.1) allowing incoming new connections to be directly assigned by host 300.

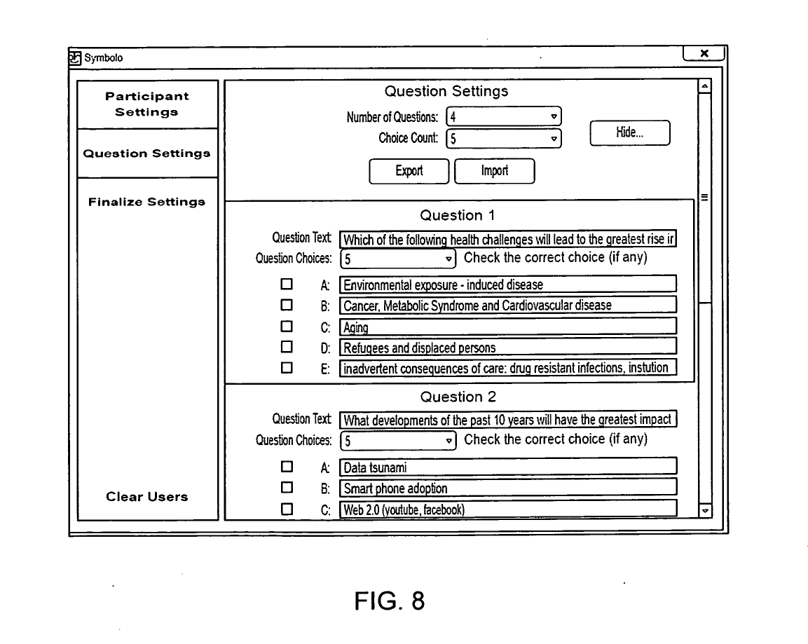

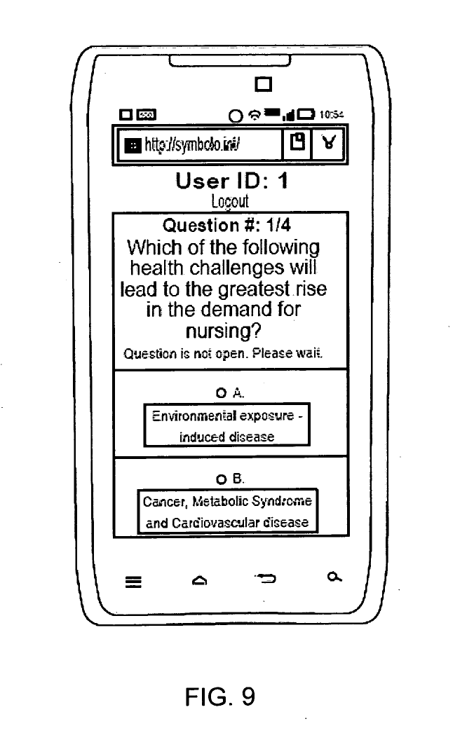

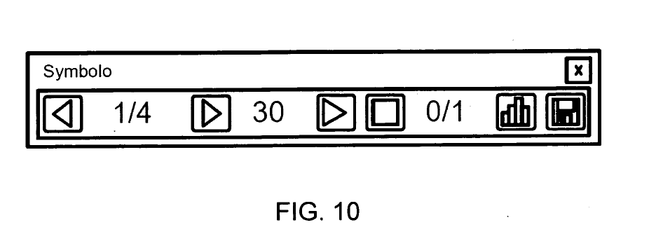

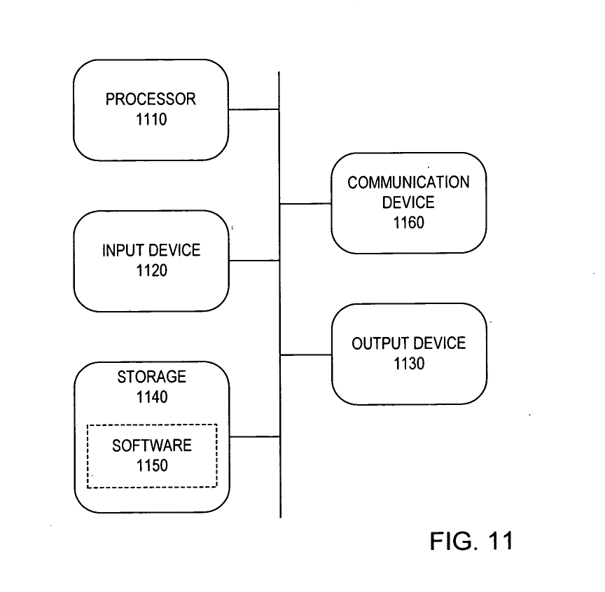

FIG. 8 illustrates an example of a setup user interface for an audience response system. In this user interface, a lecturer can input questions to be used in the audience response system. FIG. 9 illustrates an example of a client device user interface for an audience response system, and shows the display of the questions input by the lecturer via the user interface shown in FIG. 8. FIG. 10 illustrates an example of an administrator console user interface for an audience response system. This console user interface (also shown in FIG. 3 on the screen of host 300) can enable the lecturer to operate the audience response system.

The console user interface can be operated by pressing the left and right arrows adjacent the “¼” to move through the displayed questions, pressing the play or stop buttons to the right of “30” to play or stop play of a screen, pressing the graph button to the right of “Oh” to bring up a graph per question showing real-time results of the user's responses, and pressing the save button to the right of the graph button to save a session.

The setup for a typical user of the audience response system can comprise the user taking his or her WiFi capable device, with browser, and connecting to the wireless intranet. The user then opens the browser which can automatically redirect them to the proper intranet webpage, via captive web portal. The user can register and then has several options of how to proceed. After selecting an option, the user can join a session and is now able to participate. At the conclusion of the session the user can have the option of a printout of his or her current grades.

A main advantage of this system is in cutting costs. This system aims to make using electronic response devices for a variety of purposes more prolific by making it more cost effective to deploy. With the system of the present disclosure, expensive proprietary servers and response devices can be supplanted by WiFi enabled devices on a local intranet connected to a server running the aforementioned supported operating systems. In a class room scenario teachers often have to worry about students being distracted by their electronics, however if the student is using their phone or computer for school work it becomes a learning aid.

Current technology utilizes proprietary clicker devices and proprietary response machines, as well as an ancient form of communication. Most current “clicker” technology runs off of infrared receivers which is both expensive and archaic. Newer technologies may utilize WiFi but still require overly expensive proprietary devices. Some other technologies also require a mandatory Internet connection, which is not possible in most conference centers and in school buildings. and college campuses. The intranet based, no-limits, WiFi based technology of the present disclosure cuts costs tremendously in this aspect.

Teachers utilizing the administrative software of the audience response system can upload their questions for the class as well as choose to integrate power point presentations. As well during the class, the teacher can demand a graph per question showing real-time results of the student's responses. Games can also be implemented as a function of the software allowing the teacher to play “jeopardy” style games, as well as others, with the class using this software. The software running on the application server is also able to query data from an SQL database and from this teachers can get information relating to how many people selected a certain answer and from this recognize trends. This data can be exported into a Microsoft Excel spreadsheet for later analysis.

Conferences of various sizes can benefit from audience response systems to aid in discussion and collecting audience statistics. Not needing to rent an audience response system saves money and makes everyone responsible for their own devices. This prevents theft of property which traditionally incurs further fees. With the system of the present disclosure, the only cost to the convention organizers is that of the servers and networking equipment, as well as the license for this software, as they scale to the size of the conference. Furthermore because the system utilizes an intranet there is no need for convention organizers to pay for expensive WiFi services provided by the convention center owners.

The potential for this audience response system also extends to sporting arenas as well as cinemas which can utilize it to answer trivia questions between innings or quarters for audience entertainment, as well as pushing advertisements directly to user's for the venue's gain. These advertisements can be in the form of videos or images, and can be streamed over the same network as the audience response data.

Thus, the network of the present disclosure can be applied to any suitable use in the context of an audience response system, such as classroom settings including university centralization, corporate/government/military, movie theaters, sporting events and arenas such as stadiums or free standing fields, cruise ships, restaurants for taking orders, Democratic/Republican National Conventions (government), public venues, private meetings, game shows such as “who wants to be a millionaire,” concert halls, any private or public venue where polling, testing, surveying, etc. is made, and any scientific, medical, sociological testing scenario where group data is taken and used for statistical analysis.

Further, the network of the present disclosure is not limited to audience response applications and can be used to implement any suitable network application. For example, the network can be used in a department store such as Ikea, which can locally host an application that users can connect to with the smartphones that allow them to browse a store, select objects, have a list of objects they selected, scan barcode to get prices, or add items to a cart to pick up at a desk at a later date.

The network can be used in a public transit location such as Port Authority, MTA subway, and airports and locally host an application/website which allows users to connect and check flight statuses, book tickets, pickup tickets, check train/bus schedules, check for delays of any of the above mentioned public transit systems, as well as for dispatching or giving dispatching approval to all of the above mentioned public transit systems. The transit authority can also host advertisements on these systems.

The network can be used in a generic company or other organization and locally host an application on a private secure system which allows anyone to connect. Examples of locally hostable applications are a data backup application, data transmission application, payroll data application or any other application which may not require Internet access or be accessible outside of the specific cloud.

The network can be used in a fast food restaurant such as Sonic or a fine dining chain such as Cheesecake factory with a locally hosted application that users can connect wirelessly to for the ability of viewing a menu, being forced adverts from the food establishment, placing an order, getting status about placed order, etc.

The network can be used for secure entry such as locks in hospital wards, etc, comprising a wireless solution which can utilize the network, and a non-public SSID, that can allow all HID/RFID scanners to be connected wirelessly to a hosted application/database.

The network can be used for use in gaming tournaments and large gaming ventures. Most computer games, and some console games, require repeated authentication by sending a packet to an authentication server and then receiving a packet back authenticating a game. At tournaments this has led to immense lag time occasionally bringing down entire convention halls to bringing down the main gaming servers themselves. By hosting a mirror of the gaming server on the network of the present disclosure the speed of a connection can be increased roughly by 100× in comparison to an over-the-internet gaming method.

The network can be used for use in VoIP systems for large corporations or ISPs. VoIP is starting to become extremely useful to large corporations, and offered as a service to ISPs. However VoIP is relatively unsecure when being used on the same network as Internet access. Hosting the VoIP application on the network of the present disclosure can alleviate these concerns, and reduce hardware and maintenance costs as all phones would be located on one network, with no outside access.

The network can be used for use in grocery stores and big box stores such as Costco and Sears. By setting up a laptop or other computing device with a router and running an application on that, any user in a certain range can connect to the wireless connection, scan prices, see reviews and stock, and also see commercials for certain products. This can be hosted on the local intranet with no need for Internet or data access.

The network can be used for use in research labs. Running an intranet according to the present disclosure in a laboratory is extremely safer and less costly than having all the computers hooked up to the Internet. Further, one can set up an automation application located on the main intranet server which can talk to all other terminals in the lab and can automate research efforts in the lab.

The network can be used for use in home automation. Home automation is becoming more popular. Running a central application off of an intranet according to the present disclosure that speaks to all compliant automation devices can be a much less costlier way of setting up home automation systems as well as being able to have a larger radius of coverage than currently offered by RF technology.

The network can be used for use in Hospitals as an electronic medical record tool. Currently most hospitals records are stored on servers located off site, and most of the time, out of state. Patients wear some sort of identifier such as a barcode and the health provider scans the barcode and patient data gets returned. However, due to the foreign location of the servers this process is most often lengthy. By running either a mirror or the actual electronic record application on an intranet according to the present disclosure, speeds can be increased by approximately 100× in comparison to standard Internet speeds.

The network can be used for use in ISP control. ISPs can set up several intranets according to the present disclosure, which can host applications linking them together and linking them to their main DNS server, and place end users in intranets accordingly in an effort to have more control over content the end user can see and things the end user can download. This can decrease ISP overhead and cost and give the ISP more control over the end user.

For all the options listed above, the respective institutions or organizations that set up the application can also host their own advertisements on the system of the present disclosure and lease out advertisement space to allow for additional revenue.

FIG. 11 shows a block diagram of an example of a computing device, which may generally correspond to host 100, wireless communication point 130, client 150, client 155 and client 160. The form of computing device 1100 may be widely varied. For example, computing device 1100 can be a personal computer, workstation, server computing device, portable computing device, or any other suitable type of microprocessor-based device. Computing device 1100 can include, for example, one or more components including processor 1110, input device 1120, output device 1130, storage 1140, and communication device 1160. These components may be widely varied, and can be connected to each other in any suitable manner, such as via a physical bus, network line or wirelessly for example.

For example, input device 1120 may include a keyboard, mouse, touch screen or monitor, voice-recognition device, or any other suitable device that provides input. Output device 1130 may include, for example, a monitor, printer, disk drive, speakers, or any other suitable device that provides output.

Storage 1140 may include volatile and/or nonvolatile data storage, such as one or more electrical, magnetic or optical memories such as a RAM, cache, hard drive, CD-ROM drive, tape drive or removable storage disk for example. Communication device 1160 may include, for example, a network interface card, modem or any other suitable device capable of transmitting and receiving signals over a network.

Network 140 may include any suitable interconnected communication system, such as a local area network (LAN) or wide area network (WAN) for example. Network 140 may implement any suitable communications protocol and may be secured by any suitable security protocol. The corresponding network links may include, for example, telephone lines, DSL, cable networks, T1 or T3 lines, wireless network connections, or any other suitable arrangement that implements the transmission and reception of network signals.

Software 1150 can be stored in storage 1140 and executed by processor 1110, and may include, for example, programming that embodies the functionality described in the various embodiments of the present disclosure. The programming may take any suitable form. Software 1150 may include, for example, the network components of host 100 described above.

Software 1150 can also be stored and/or transported within any computer-readable storage medium for use by or in connection with an instruction execution system, apparatus, or device, such as computing device 1100 for example, that can fetch instructions associated with the software from the instruction execution system, apparatus, or device and execute the instructions. In the context of this document, a computer-readable storage medium can be any medium, such as storage 1140 for example, that can contain or store programming for use by or in connection with an instruction execution.system, apparatus, or device.

Software 1150 can also be propagated within any transport medium for use by or in connection with an instruction execution system, apparatus, or device, such as computing device 1100 for example, that can fetch instructions associated with the software from the instruction execution system, apparatus, or device and execute the instructions. In the context of this document, a transport medium can be any medium that can communicate, propagate or transport programming for use by or in connection with an instruction execution system, apparatus, or device. The transport readable medium can include, but is not limited to, an electronic, magnetic, optical, electromagnetic or infrared wired or wireless propagation medium.

It will be appreciated that the above description for clarity has described embodiments of the disclosure with reference to different functional units and processors. However, it will be apparent that any suitable distribution of functionality between different functional units or processors may be used without detracting from the disclosure. For example, functionality illustrated to be performed by separate systems may be performed by the same system, and functionality illustrated to be performed by the same system may be performed by separate systems. Hence, references to specific functional units may be seen as references to suitable means for providing the described functionality rather than indicative of a strict logical or physical structure or organization.

The disclosure may be implemented in any suitable form, including hardware, software, firmware, or any combination of these. The disclosure may optionally be implemented partly as computer software running on one or more data processors and/or digital signal processors. The elements and components of an embodiment of the disclosure may be physically, functionally, and logically implemented in any suitable way. Indeed, the functionality may be implemented in a single unit, in multiple units, or as part of other functional units. As such, the disclosure may be implemented in a single unit or may be physically and functionally distributed between different units and processors.

One skilled in the relevant art will recognize that many possible modifications and combinations of the disclosed embodiments can be used, while still employing the same basic underlying mechanisms and methodologies. The foregoing description, for purposes of explanation, has been written with references to specific embodiments. However, the illustrative discussions above are not intended to be exhaustive or to limit the disclosure to the precise forms disclosed. Many modifications and variations can be possible in view of the above teachings. The embodiments were chosen and described to explain the principles of the disclosure and their practical applications, and to enable others skilled in the art to best utilize the disclosure and various embodiments with various modifications as suited to the particular use contemplated.

Further, while this specification contains many specifics, these should not be construed as limitations on the scope of what is being claimed or of what may be claimed, but rather as descriptions of features specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

What is claimed is:

1. A system comprising:
a host computing device associated with a network;
a first network component installed on the host computing device, the first network component comprising a server configured to assign a network address to a client computing device connecting to the network;
a second network component installed on the host computing device, the second network component comprising a server configured to resolve a network name into a network address associated with the network; and
a third network component installed on the host computing device, the third network component comprising a server configured to provide an application on the network.

2. The system of claim 1, comprising a fourth network component installed on the network, the fourth network component comprising a transceiver configured to transmit wireless signals to one or more client computing devices connected to the network and to receive wireless signals from the one or more client computing devices.

3. The system of claim 2, wherein the fourth network component is configured to forward to the host computing device all data received from the one or more client computing devices.

4. The system of claim 3, comprising a fifth network component installed on the host computing device, the fifth network component comprising a port to which the data received by the fourth network component is addressed.

5. The system of claim 4, wherein the fourth network component comprises a device connectable to the host computing device via a wired network line.

6. The system of claim 4, wherein the fourth network component is installed on the host computing device.

7. The system of claim 1, wherein the first network component, the second network component and the third network component communicate with each other via a loopback interface.

8. The system of claim 1, wherein the host computing device comprises a portable computing device.

9. The system of claim 1, wherein the host computing device comprises a server computing device mounted in a non-portable enclosure.

10. The system of claim 1, wherein the first network component comprises a DHCP server.

11. The system of claim 1, wherein the second network component comprises a DNS server.

12. The system of claim 1, wherein the third network component comprises a web server.

13. The system of claim 1, wherein the application comprises a group response application configured to conduct an interactive event with a group of people carrying client computing devices within a range of the fourth network component.

14. The system of claim 1, wherein the network is not connected to the Internet.

15. A method comprising:
assigning, by a first network component installed on a host computing device associated with a network, a network address to a client computing device connecting to the network;
resolving, by a second network component installed on the host computing device, a network name into a network address associated with the network; and
providing, by a third network component installed on the host computing device, an application on the network.

16. The system of claim 15, comprising a fourth network component installed on the network and configured to forward to the host computing device all data wirelessly received from one or more client computing devices connected to the network.

17. The system of claim 15, wherein the first network component, the second network component and the third network component communicate with each other via a loopback interface.

18. A system comprising:
a first network device assigned a host address of a network, the first network device comprising a server configured to assign a network address to a client computing device connecting to the network;
a second network device assigned the host address of the network, the second network device comprising a server configured to resolve a network name into a network address associated with the network; and
a third network device assigned the host address of the network, the third network device comprising a server configured to provide an application on the network.

19. The system of claim 18, comprising a fourth network device installed on the network and configured to forward to the host address all data wirelessly received from one or more client computing devices connected to the network.

20. The system of claim 18, wherein the first network device, the second network device and the third network device communicate with each other via a loopback interface.
